(19) United States
(12) Patent Application Publication
(10) Pub. No.: US 2025/0116359 A1
(43) Pub. Date: Apr. 10, 2025

(54) Four piece clamp system

(71) Applicant: Contour Biosolutions, LLC, Middlesex, NJ (US)

(72) Inventor: Louis Bongiorno, Millington, NJ (US)

(73) Assignee: Contour Biosolutions, LLC, Middlesex, NJ (US)

(21) Appl. No.: 18/895,920

(22) Filed: Sep. 25, 2024

Related U.S. Application Data
(60) Provisional application No. 63/588,793, filed on Oct. 9, 2023.

(51) Int. Cl. F16L 23/04

(52) U.S. Cl. CPC F16L 23/04

(57) ABSTRACT

A clamp system includes a first clamp having a first clamp first section and a first clamp second section. The clamp system also includes a second clamp having a second clamp first section and a second clamp second section. Further, the clamp system includes a joining member having a cylindrical section with opposing protrusions attached to and extending from an outer edge thereof. The first clamp first section is configured to engage with the first protrusion and the second protrusion at an upper portion of a first sidewall of said first protrusion and second protrusion. The first clamp second section is configured to engage with the first protrusion and the second protrusion at a lower portion of the first sidewall of said first protrusion and second protrusion. Similarly, the second clamp first section is configured to engage with the first protrusion and the second protrusion at an upper portion of a second sidewall of said first protrusion and second protrusion. The second clamp second section is configured to engage with the first protrusion and the second protrusion at a lower portion of the second sidewall of said first protrusion and second protrusion.

### CROSS REFERENCES AND PRIORITIES

This Application claims priority from U.S. Provisional Application No. 63/588,793 filed on 9 Oct. 2023, the teachings of which are incorporated by reference herein in their entirety.

### BACKGROUND

Chemical manufacturing, particularly pharmaceutical manufacturing, often requires aseptic sealing of the vessel within which the manufacturing process occurs and within the lines and conduits connected to said vessel. Aseptic sealing in such manufacturing typically requires the aseptic seal to withstand the pressures associated with the manufacturing process without leaking, breaking, or rupturing. A number of clamps, valves, connectors, and other fasteners have been developed to provide aseptic sealing of chemical manufacturing equipment in pressurized environments.

Recently, many chemical manufacturing processes have transitioned to single-use processing equipment as opposed to reusable processing systems which require stringent sterilization regimes using harsh chemicals and high temperature steam after each use. Single-use systems conduct the entire duration of the production process in a single batch, utilizing processing equipment that is transported off-site for sterilization using gamma, EtO, or x-ray sterilization methods. These methods provide greater assurance of sterility at a lower cost than steam sterilizing multi-use metal systems. The requirement of replacing the entire process assembly creates a need for products that assemble quickly and accurately.

Single-use processing equipment—in which the various components are typically manufactured of a polymer material as opposed to metals found in reusable processing systems—suffers from several flaws when compared to reusable processing systems. Most notably, an entire processing system must be assembled for each production batch. This process is time consuming and labor intensive—often conducted by hand by several individuals operating in a clean-room environment. In addition, the multitude of conduits and connections involved in any one single-use system increases the chances that any one connection may be assembled without maintaining aseptic sealing and/or without maintaining sealing capable of withstanding manufacturing pressures when the system is in operation without leaking, breaking, or rupturing.

The need exists, therefore, for improved equipment for assembling single-use aseptic pressurized chemical manufacturing systems which can be assembled quickly and easily by hand.

### SUMMARY

Disclosed herein is a clamp system comprising a first clamp, a second clamp, and a joining member. The first clamp comprising a first clamp first section and a first clamp second section. The second clamp comprising a second clamp first section and a second clamp second section.

The first clamp first section has a first semi-circular wall, a first wall first engagement member, and a first wall second engagement member. The first semi-circular wall has a first inner surface, a first outer surface, a first wall first end point, and a first wall second end point. The first wall first engagement member is attached to the first outer surface at the first wall first end point. The first wall second engagement member is attached to the first outer surface at the first wall second end point.

The first clamp second section has a second semi-circular wall, a second wall first engagement member, and a second wall second engagement member. The second semi-circular wall has a second inner surface, a second outer surface, a second wall first end point, and a second wall second end point. The second wall first engagement member is attached to the second outer surface at the second wall first end point. The second wall second engagement member is attached to the second outer surface at the second wall second end point.

The second clamp first section has a third semi-circular wall, a third wall first engagement member, and a third wall second engagement member. The third semi-circular wall has a third inner surface, a third outer surface, a third wall first end point, and a third wall second end point. The third wall first engagement member is attached to the third outer surface at the third wall first end point. The third wall second engagement member is attached to the third outer surface at the third wall second end point.

The second clamp second section has a fourth semi-circular wall, a fourth wall first engagement member, and a fourth wall second engagement member. The fourth semi-circular wall has a fourth inner surface, a fourth outer surface, a fourth wall first end point, and a fourth wall second end point. The fourth wall first engagement member is attached to the fourth outer surface at the fourth wall first end point. The fourth wall second engagement member is attached to the fourth outer surface at the fourth wall second end point.

The joining member comprises a cylindrical section, a first protrusion, and a second protrusion. The first protrusion is attached to and extends from a cylindrical section outer edge. The second protrusion is attached to and extends from the cylindrical section outer edge at a position approximately 180° apart from the first protrusion about a circumference of the cylindrical section.

The first wall first engagement member is configured to connect to a first portion of the first protrusion. The first wall second engagement member is configured to connect to a first portion of the second protrusion. The second wall first engagement member is configured to connect to a second portion of the first protrusion. The second wall second engagement member is configured to connect to a second portion of the second protrusion. The third wall first engagement member is configured to connect to a third portion of the first protrusion. The third wall second engagement member is configured to connect to a third portion of the second protrusion. The fourth wall first engagement member is configured to connect to a fourth portion of the first protrusion. The fourth wall second engagement member is configured to connect to a fourth portion of the second protrusion.

In some embodiments, the first wall first engagement member may comprise a first channel comprising a plurality of first channel teeth, the first wall second engagement member may comprise a second channel comprising a plurality of second teeth, the second wall first engagement member may comprise a third channel comprising a plurality of third channel teeth, and the second wall second engagement member may comprise a fourth channel comprising a plurality of fourth channel teeth. In such embodiments, the first protrusion may comprise a first protrusion first sidewall comprising a first plurality of teeth and a second plurality of teeth, and the second protrusion may comprise a second protrusion first sidewall comprising a third plurality of teeth and a fourth plurality of teeth. The first clamp first section may be configured to connect to the joining member by engaging the plurality of first channel teeth to the first plurality of teeth and the plurality of second channel teeth to third plurality of teeth. The first clamp second section may be configured to connect to the joining member by engaging the plurality of third channel teeth to the second plurality of teeth and the plurality of fourth channel teeth to the fourth plurality of teeth.

In certain embodiments, the plurality of first channel teeth may be arranged vertically along at least a portion of a first bottom wall of the first channel, the plurality of second channel teeth may be arranged vertically along at least a portion of a second bottom wall of the second channel, the plurality of third channel teeth may be arranged vertically along at least a portion of a third bottom wall of the third channel, and the plurality of fourth channel teeth may be arranged vertically along at least a portion of a fourth bottom wall of the fourth channel. In some embodiments, the first plurality of teeth may be arranged vertically along an upper portion of the first protrusion first sidewall, the second plurality of teeth may be arranged vertically along a lower portion of the first protrusion first sidewall, the third plurality of teeth may be arranged vertically along an upper portion of the second protrusion first sidewall, and the fourth plurality of teeth may be arranged vertically along a lower portion of the second protrusion first sidewall.

In some embodiments, the third wall first engagement member may comprise a fifth channel comprising a plurality of fifth channel teeth, the third wall second engagement member may comprise a sixth channel comprising a plurality of sixth channel teeth, the fourth wall first engagement member may comprise a seventh channel comprising a plurality of seventh channel teeth, and the fourth wall second engagement member may comprise an eighth channel comprising a plurality of eighth channel teeth. In such embodiments, the first protrusion may comprise a first protrusion second sidewall comprising a fifth plurality of teeth and a sixth plurality of teeth, and the second protrusion may comprise a second protrusion second sidewall comprising a seventh plurality of teeth and an eighth plurality of teeth. The second clamp first section may be configured to connect to the joining member by engaging the plurality of fifth channel teeth to the plurality of fifth teeth and engaging the plurality of sixth channel teeth to the seventh plurality of teeth. The second clamp second section may be configured to connect to the joining member by engaging the plurality of seventh channel teeth to the plurality of sixth teeth and engaging the plurality of eighth channel teeth to the eighth plurality of teeth.

In certain embodiments, the plurality of fifth channel teeth may be arranged vertically along at least a portion of a fifth bottom wall of the fifth channel, the plurality of sixth channel teeth may be arranged vertically along at least a portion of a sixth bottom wall of the sixth channel, the plurality of seventh channel teeth may be arranged vertically along at least a portion of a seventh bottom wall of the seventh channel, and the plurality of eight channel teeth may be arranged vertically along at least a portion of an eighth bottom wall of the eighth channel. In some embodiments, the fifth plurality of teeth may be arranged vertically along an upper portion of the first protrusion second sidewall, the sixth plurality of teeth may be arranged vertically along a lower portion of the first protrusion second sidewall, the seventh plurality of teeth may be arranged vertically along an upper portion of the second protrusion second sidewall, and the eighth plurality of teeth may be arranged vertically along a lower portion of the second protrusion second sidewall.

In some embodiments, the first protrusion may comprise a first protrusion channel located between the first protrusion first sidewall and the first protrusion second sidewall. In certain embodiments, the second protrusion may comprise a second protrusion channel located between the second protrusion first sidewall and the second protrusion second sidewall.

In certain embodiments, the first wall first engagement member may comprise a first hinge section and the first wall second engagement member may comprise a first plurality of inwardly facing teeth. In such embodiments, the second wall first engagement member may comprise a second hinge section and the second wall second engagement member may comprise a first plurality of outwardly facing teeth. The first clamp first section may be configured to connect to the first clamp second section by mating the first hinge section to the second hinge section and mating the first plurality of inwardly facing teeth to the first plurality of outwardly facing teeth.

In some embodiments, the first semi-circular wall may include a first clamping surface which is angled inwardly from the first inner surface towards the first outer surface. The second semi-circular wall may include a second clamping surface which is angled inwardly from the second inner surface towards the second outer surface.

In certain embodiments, the third semi-circular wall may include a third clamping surface which is angled inwardly from the third inner surface towards the third outer surface. The fourth semi-circular wall may include a fourth clamping surface which is angled inwardly from the fourth inner surface towards the fourth outer surface.

In some embodiments, the first clamp is comprised of a material selected from the group consisting of polymeric materials, glass filled polymer materials, and silicone materials. In certain embodiments, the second clamp is comprised of a material selected from the group consisting of polymeric materials, glass filled polymer materials, and silicone materials. In some embodiments, the joining member is comprised of a material selected from the group consisting of polymeric materials, glass filled polymer materials, and silicone materials.

### BRIEF DESCRIPTION OF FIGURES

FIG. 1 is a perspective view of a clamp system.

FIG. 2 is an exploded view of a clamp system.

FIG. 3 is an exploded axial cross-section of a clamp system.

FIG. 4 is an assembled axial cross-section of the clamp system of FIG. 3.

FIG. 5 is an exploded axial cross-section of a clamp system.

FIG. 6 is an assembled axial cross-section of the clamp system of FIG. 5.

FIG. 7 is a perspective view of one step in assembling a clamp system.

FIG. 8 is a perspective view of a second step in assembling a clamp system.

FIG. 9 is a perspective view of a third step in assembling a clamp system.

FIG. 10 is a partially exploded view of a clamp system.

FIG. 11 is a partially exploded front view of a clamp system.

FIG. 12 is a perspective view of an assembled clamp system.

### DETAILED DESCRIPTION

Disclosed herein is a clamp system. The clamp system is described below with reference to the Figures. As described herein, the following numbers refer to the following structures as noted in the Figures.
10 refers to a clamp system.
100 refers to a first clamp.
110 refers to a first clamp first section.
120 refers to a first semi-circular wall.
121 refers to a first inner surface.
122 refers to a first outer surface.
123 refers to a first wall first end point.
124 refers to a first wall second end point.
130 refers to a first wall first engagement member.
131 refers to a first channel.
132 refers to a plurality of first channel teeth.
133 refers to a first bottom wall.
134 refers to a first hinge section.
140 refers to a first wall second engagement member.
141 refers to a second channel.
142 refers to a plurality of second channel teeth.
143 refers to a second bottom wall.
144 refers to a plurality of inwardly facing teeth.
145 refers to a first thumb protrusion.
150 refers to a first clamp second section.
160 refers to a second semi-circular wall.
161 refers to a second inner surface.
162 refers to a second outer surface.
163 refers to a second wall first end point.
164 refers to a second wall second end point.
170 refers to a second wall first engagement member.
171 refers to a third channel.
172 refers to a plurality of third channel teeth.
173 refers to a third bottom wall.
174 refers to a second hinge section.
180 refers to a second wall second engagement member.
181 refers to a fourth channel.
182 refers to a plurality of fourth channel teeth.
183 refers to a fourth bottom wall.
184 refers to a plurality of outwardly facing teeth.
185 refers to a second thumb protrusion.
200 refers to a second clamp.
210 refers to a second clamp first section.
220 refers to a third semi-circular wall.
221 refers to a third inner surface.
222 refers to a third outer surface.
223 refers to a third wall first end point.
224 refers to a third wall second end point.
230 refers to a third wall first engagement member.
231 refers to a fifth channel.
232 refers to a plurality of fifth channel teeth.
233 refers to a fifth bottom wall.
240 refers to a third wall second engagement member.
241 refers to a sixth channel.
242 refers to a plurality of sixth channel teeth.
243 refers to a sixth bottom wall.
250 refers to a second clamp second section.
260 refers to a fourth semi-circular wall.
261 refers to a fourth inner surface.
262 refers to a fourth outer surface.
263 refers to a fourth wall first end point.
264 refers to a fourth wall second end point.
270 refers to a fourth wall first engagement member.
271 refers to a seventh channel.
272 refers to a plurality of seventh channel teeth.
273 refers to a seventh bottom wall.
280 refers to a fourth wall second engagement member.
281 refers to an eighth channel.
282 refers to a plurality of eighth channel teeth.
283 refers to an eighth bottom wall.
300 refers to a joining member.
310 refers to a cylindrical section.
311 refers to a cylindrical section outer edge.
312 refers to an opening.
313 refers to a cylindrical section first face.
314 refers to a cylindrical section second face.
315 refers to a sealing member.
320 refers to a first protrusion.
321 refers to a first protrusion first sidewall.
322 refers to a first protrusion second sidewall.
323 refers to a first plurality of teeth.
324 refers to a second plurality of teeth.
325 refers to a fifth plurality of teeth.
326 refers to a sixth plurality of teeth.
327 refers to a first protrusion channel.
330 refers to a second protrusion.
331 refers to a second protrusion first sidewall.
332 refers to a second protrusion second sidewall.
333 refers to a third plurality of teeth.
334 refers to a fourth plurality of teeth.
335 refers to a seventh plurality of teeth.
336 refers to an eighth plurality of teeth.
337 refers to a second protrusion channel.
400 refers to a first conduit section.
410 refers to a first flange.
420 refers to a first flange face.
430 refers to a first o-ring groove.
500 refers to a second conduit section.
510 refers to a second flange.
520 refers to a second flange face.
530 refers to a second o-ring groove.

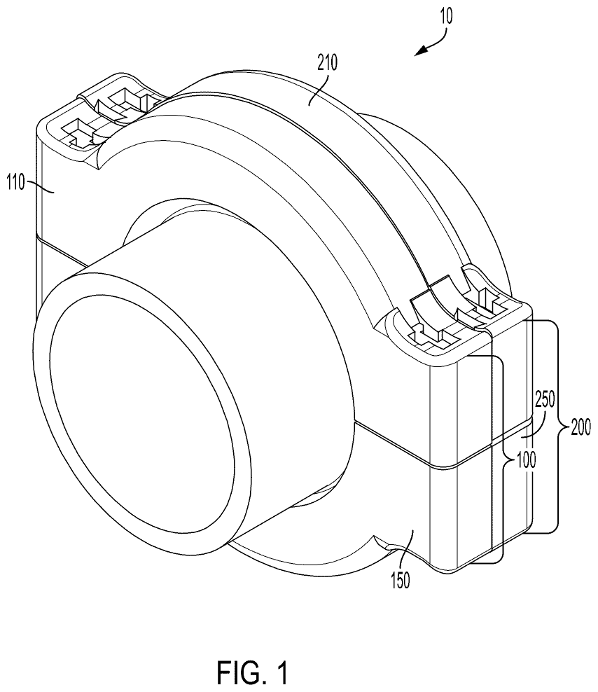

FIG. 1 shows a perspective view of a clamp system (10). As shown in FIG. 1, the clamp system includes a first clamp (100) and a second clamp (200) with the first clamp comprising at least two clamp sections—a first clamp first section (110) and a first clamp second section (150). Similarly, the second clamp comprises at least two clamp sections—a second clamp first section (210) and a second clamp second section (250).

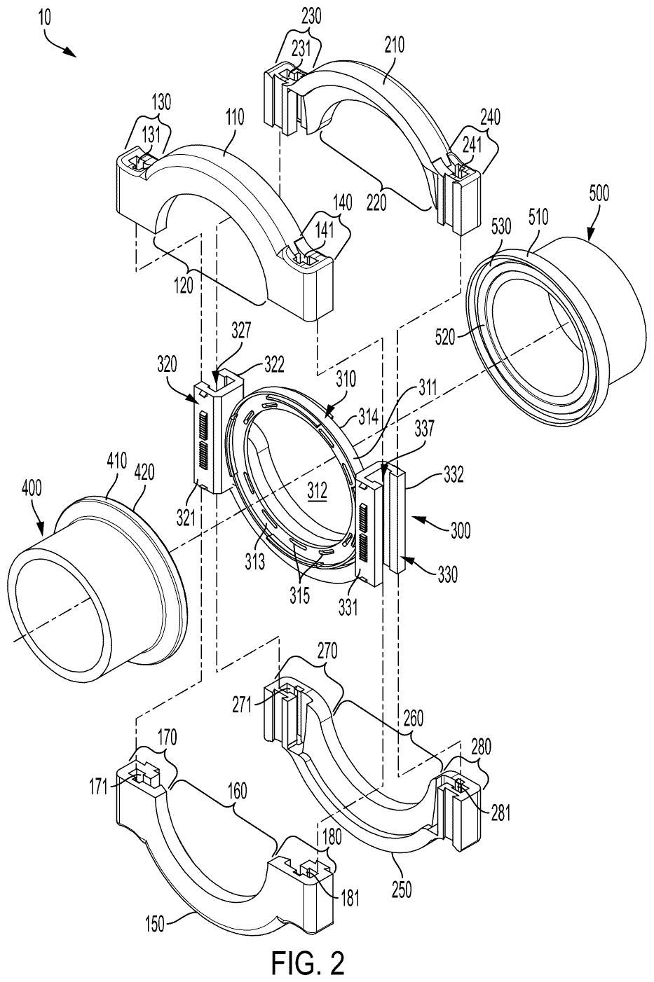

FIG. 2 shows an exploded view of the clamp system (10) including additional details of the first clamp (100) and the second clamp (200). FIG. 2 also shows the clamp system including a joining member (300). The joining member includes a cylindrical section (310) having a cylindrical section outer edge (311). Attached to and extending from a first position along the cylindrical section outer edge is a first protrusion (320). A second protrusion (330) is attached to and extends from a second position along the cylindrical section outer edge. In embodiments where the clamp sections are configured in two pieces with each piece being approximately or exactly half of the clamp split radially, the second protrusion may be located at a position approximately 180° apart from the first protrusion about the circumference of the cylindrical section.

Each of the first protrusion (320) and the second protrusion (330) may include a pair of opposing sidewalls. That is to say that the first protrusion may include a first protrusion first sidewall (321) and a first protrusion second sidewall (322) opposing the first protrusion first sidewall. Similarly, the second protrusion may include a second protrusion first sidewall (331) and a second protrusion second sidewall (332) opposing the first protrusion first sidewall.

The cylindrical section (310) may include an opening (312) substantially parallel with or parallel with a central axis thereof. The opening allows fluid from the first conduit section (400) to flow through the joining member (300) into the second conduit section (500) or vice versa.

Opposing faces (313 and 314) of the cylindrical section (310) may include one or more sealing members (315). These sealing members—which may take the form of a gasket, an o-ring, or the like—may be configured to engage a corresponding sealing structure—such as a flange face (420/520), an o-ring groove (430/530), or the like—of the first conduit section (400) and second conduit section (500) respectively to improve sealing between the clamp system (10) and the conduit sections.

In certain embodiments, such as shown in FIG. 2, the first protrusion (320) with its opposing sidewalls may include a first protrusion channel (327) located between the opposing sidewalls of the first protrusion. Similarly, the second protrusion (330) may include a second protrusion channel (337) located between the opposing sidewalls of the second protrusion.

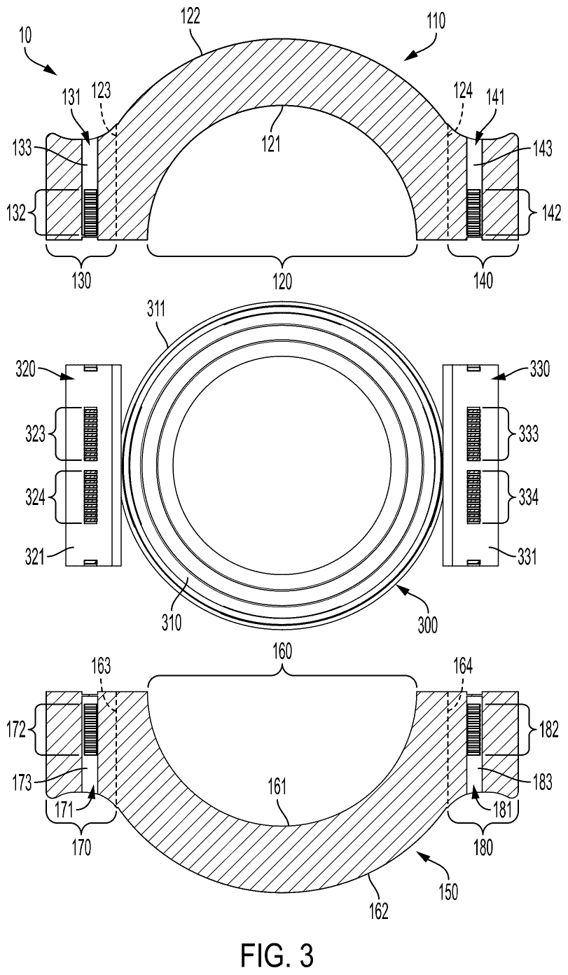

As further shown in FIG. 2, the first clamp first section (110) includes a first semi-circular wall (120). Attached to opposing end points ((123) and (124) as shown in FIG. 3) of the first semi-circular wall are a first wall first engagement member (130) and a first wall second engagement member (140). In certain embodiments, the first wall first engagement member and/or the first wall second engagement member may take the form of a first channel (131) and a second channel (141) respectively as described herein and shown in FIG. 2.

Similarly, the first clamp second section (150) includes a second semi-circular wall (160). Attached to opposing end points ((163) and (164) as shown in FIG. 3) of the second semi-circular wall are a second wall first engagement member (170) and a second wall second engagement member (180). In certain embodiments, the second wall first engagement member and/or the second wall second engagement member may take the form of a third channel (171) and a fourth channel (181) respectively as described herein and shown in FIG. 2.

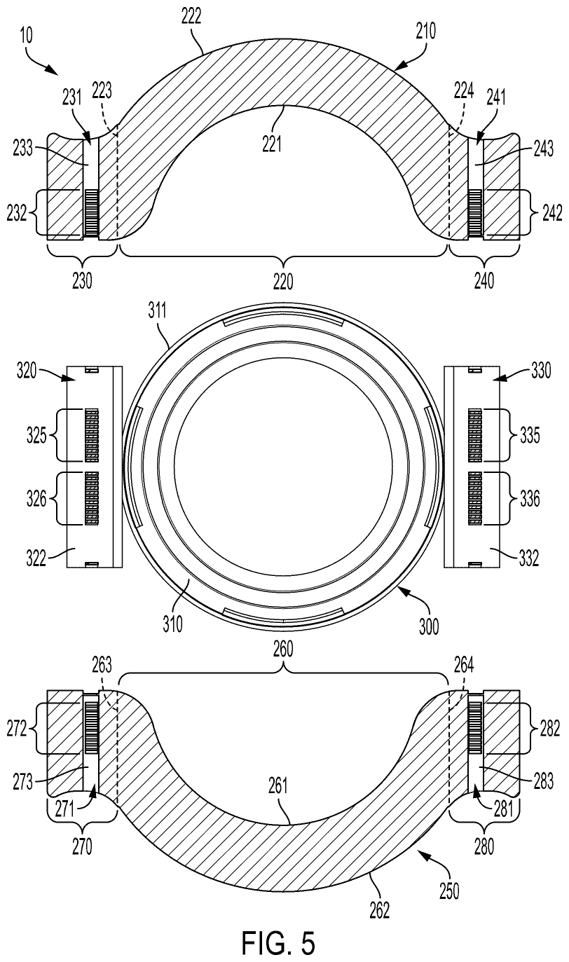

The second clamp (200) may be of similar or identical construction to the first clamp (100). As shown in FIG. 2, the second clamp first section (210) includes a third semi-circular wall (220). Attached to opposing end points ((223) and (224) as shown in FIG. 5) of the third semi-circular wall are a third wall first engagement member (230) and a third wall second engagement member (240). In certain embodiments, the third wall first engagement member and/or the third wall second engagement member may take the form of a fifth channel (231) and a sixth channel (241) respectively as described herein and shown in FIG. 2.

Similarly, the second clamp second section (250) includes a fourth semi-circular wall (260). Attached to opposing end points ((263) and (264) as shown in FIG. 5) of the fourth semi-circular wall are a fourth wall first engagement member (270) and a fourth wall second engagement member (280). In certain embodiments, the fourth wall first engagement member and/or the fourth wall second engagement member may take the form of a seventh channel (271) and an eighth channel (281) respectively as described herein and shown in FIG. 2.

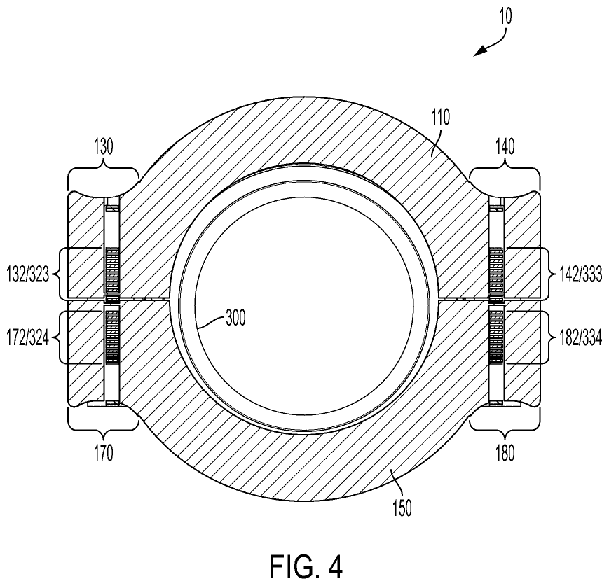

FIG. 3 shows an exploded cross-sectional view of the clamp system (10) across the central axis of the clamp system viewed from the first clamp (100) side of the clamp system with FIG. 4 showing an assembled cross-sectional view of the clamp system of FIG. 3. In FIG. 3 and FIG. 4 additional details of the first clamp and the joining member (300) are visible.

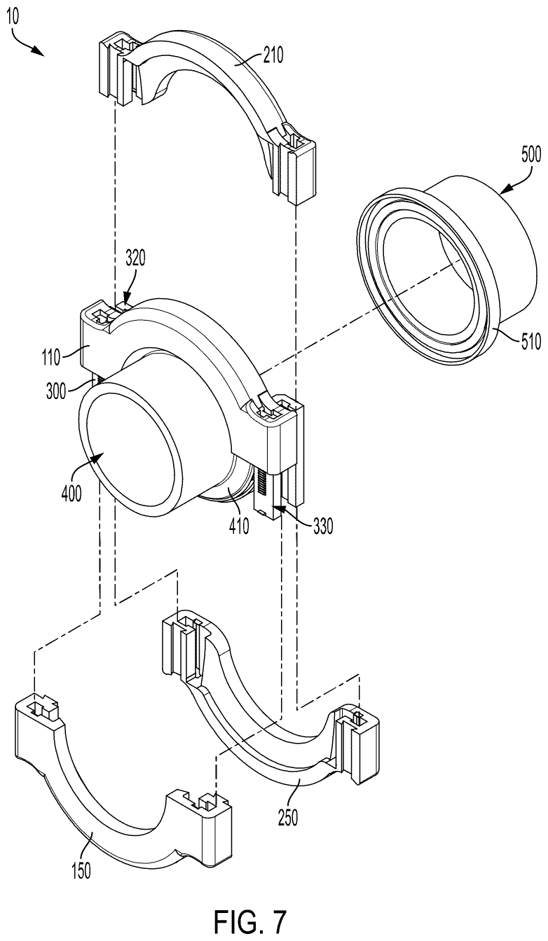

As shown in FIG. 3, the first semi-circular wall (120) of the first clamp first section (110) includes a first inner surface (121) and a first outer surface (122). The first inner surface is configured to seal to a portion of a first conduit section ((400) as shown in FIG. 7) when the clamp system (10) is assembled. The first semi-circular wall may include a first clamping surface which is angled inwardly from the inner surface towards the outer surface. As the first clamp is assembled about two sections of conduit—particularly sections of conduit having flanged terminal ends—the inwardly angled clamping surfaces force the flanged ends of the conduit closer to the joining member to achieve a tight, aseptic sealing between one section of conduit and the joining member.

FIG. 3 further shows details of certain embodiments of the first wall first engagement member (130), which is attached to the first outer surface (122) of the first semi-circular wall (120) at the first wall first end point (123). In the first wall first engagement member shown in FIG. 3 and FIG. 4, the first wall first engagement member comprises a first channel (131) with the first channel comprising a plurality of first channel teeth (132). Preferably, the plurality of first channel teeth are arranged vertically along at least a portion of a first bottom wall (133) of the first channel.

Preferably, the plurality of first channel teeth (132) are fine teeth defined by having an integral tooth dimension of at least 1.02 mm and no greater than 1.78 mm. The integral tooth dimension of the first channel teeth may also be at least 1.14 mm, or at least 1.27 mm. The integral tooth dimension of the first channel teeth may also be no greater than 1.65 mm, no greater than 1.52 mm, or no greater than 1.40 mm. The integral tooth dimension may also be defined as a range selected from the group consisting of between 1.02 mm and 1.65 mm, between 1.02 mm and 1.52 mm, between 1.02 mm and 1.40 mm, between 1.14 mm and 1.78 mm, between 1.14 mm and 1.65 mm, between 1.14 mm and 1.52 mm, between 1.14 mm and 1.40 mm, between 1.27 mm and 1.78 mm, between 1.27 mm and 1.65 mm, between 1.27 mm and 1.52 mm, and between 1.27 mm and 1.40 mm.

The first wall second engagement member (140)—attached to the first outer surface (122) of the first semi-circular wall (120) at the first wall second end point (124)—may be of similar or identical construction to the first wall first engagement member (130). That is to say that, in the first wall second engagement member shown in FIG. 3 and FIG. 4, the first wall second engagement member comprises a second channel (141) with the second channel comprising a plurality of second channel teeth (142). Preferably, the plurality of second channel teeth are arranged vertically along at least a portion of a second bottom wall (143) of the second channel.

Preferably, the plurality of second channel teeth (142) are fine teeth defined by having an integral tooth dimension of at least 1.02 mm and no greater than 1.78 mm. The integral tooth dimension of the second channel teeth may also be at least 1.14 mm, or at least 1.27 mm. The integral tooth dimension of the second channel teeth may also be no greater than 1.65 mm, no greater than 1.52 mm, or no greater than 1.40 mm. The integral tooth dimension may also be defined as a range selected from the group consisting of between 1.02 mm and 1.65 mm, between 1.02 mm and 1.52 mm, between 1.02 mm and 1.40 mm, between 1.14 mm and 1.78 mm, between 1.14 mm and 1.65 mm, between 1.14 mm and 1.52 mm, between 1.14 mm and 1.40 mm, between 1.27 mm and 1.78 mm, between 1.27 mm and 1.65 mm, between 1.27 mm and 1.52 mm, and between 1.27 mm and 1.40 mm.

FIG. 3 also shows the second semi-circular wall (160) of the first clamp second section (150). As the first clamp second section may be of similar or identical construction to the first clamp first section, the second semi-circular wall includes a second inner surface (161) and a second outer surface (162). The second inner surface is configured to seal to a portion of the first conduit section (400) when the clamp system (10) is assembled. The second semi-circular wall may include a second clamping surface which is angled inwardly from the inner surface towards the outer surface. As the first clamp is assembled about two sections of conduit—particularly sections of conduit having flanged terminal ends—the inwardly angled clamping surfaces force the flanged ends of the conduit closer to the joining member to achieve a tight, aseptic sealing between one section of conduit and the joining member.

FIG. 3 shows further details of certain embodiments of the second wall first engagement member (170), which is attached to the second outer surface (162) of the second semi-circular wall (160) at the second wall first end point (163). In the second wall first engagement member shown in FIG. 3 and FIG. 4, the second wall first engagement member comprises a third channel (171) with the third channel comprising a plurality of third channel teeth (172). Preferably, the plurality of third channel teeth are arranged vertically along at least a portion of a third bottom wall (173) of the third channel.

Preferably, the plurality of third channel teeth (172) are fine teeth defined by having an integral tooth dimension of at least 1.02 mm and no greater than 1.78 mm. The integral tooth dimension of the third channel teeth may also be at least 1.14 mm, or at least 1.27 mm. The integral tooth dimension of the third channel teeth may also be no greater than 1.65 mm, no greater than 1.52 mm, or no greater than 1.40 mm. The integral tooth dimension may also be defined as a range selected from the group consisting of between 1.02 mm and 1.65 mm, between 1.02 mm and 1.52 mm, between 1.02 mm and 1.40 mm, between 1.14 mm and 1.78 mm, between 1.14 mm and 1.65 mm, between 1.14 mm and 1.52 mm, between 1.14 mm and 1.40 mm, between 1.27 mm and 1.78 mm, between 1.27 mm and 1.65 mm, between 1.27 mm and 1.52 mm, and between 1.27 mm and 1.40 mm.

The second wall second engagement member (180)—attached to the second outer surface (162) of the second semi-circular wall (160) at the second wall second end point (164)—may be of similar or identical construction to the second wall first engagement member (170). That is to say that, in the second wall second engagement member shown in FIG. 3 and FIG. 4, the second wall second engagement member comprises a fourth channel (181) with the fourth channel comprising a plurality of fourth channel teeth (182). Preferably, the plurality of fourth channel teeth are arranged vertically along at least a portion of a fourth bottom wall (183) of the fourth channel.

Preferably, the plurality of fourth channel teeth (182) are fine teeth defined by having an integral tooth dimension of at least 1.02 mm and no greater than 1.78 mm. The integral tooth dimension of the fourth channel teeth may also be at least 1.14 mm, or at least 1.27 mm. The integral tooth dimension of the fourth channel teeth may also be no greater than 1.65 mm, no greater than 1.52 mm, or no greater than 1.40 mm. The integral tooth dimension may also be defined as a range selected from the group consisting of between 1.02 mm and 1.65 mm, between 1.02 mm and 1.52 mm, between 1.02 mm and 1.40 mm, between 1.14 mm and 1.78 mm, between 1.14 mm and 1.65 mm, between 1.14 mm and 1.52 mm, between 1.14 mm and 1.40 mm, between 1.27 mm and 1.78 mm, between 1.27 mm and 1.65 mm, between 1.27 mm and 1.52 mm, and between 1.27 mm and 1.40 mm.

As shown in FIG. 3, the first protrusion first sidewall (321) may comprise a first plurality of teeth (323) and a second plurality of teeth (324). The first plurality of teeth may be arranged vertically along an upper portion of the first protrusion first sidewall while the second plurality of teeth may be arranged vertically along a lower portion of the first protrusion first sidewall. Similarly, the second protrusion first sidewall (331) may comprise a third plurality of teeth (333) and a fourth plurality of teeth (334). The third plurality of teeth may be arranged vertically along an upper portion of the second protrusion first sidewall while the fourth plurality of teeth may be arranged vertically along a lower portion of the second protrusion first sidewall.

Preferably, the first plurality of teeth (323), the second plurality of teeth (324), the third plurality of teeth (333) and the fourth plurality of teeth (334) are each individually fine teeth defined by having an integral tooth dimension of at least 1.02 mm and no greater than 1.78 mm. The integral tooth dimension of the teeth may also be at least 1.14 mm, or at least 1.27 mm. The integral tooth dimension of the teeth may also be no greater than 1.65 mm, no greater than 1.52 mm, or no greater than 1.40 mm. The integral tooth dimension may also be defined as a range selected from the group consisting of between 1.02 mm and 1.65 mm, between 1.02 mm and 1.52 mm, between 1.02 mm and 1.40 mm, between 1.14 mm and 1.78 mm, between 1.14 mm and 1.65 mm, between 1.14 mm and 1.52 mm, between 1.14 mm and 1.40 mm, between 1.27 mm and 1.78 mm, between 1.27 mm and 1.65 mm, between 1.27 mm and 1.52 mm, and between 1.27 mm and 1.40 mm.

As shown in FIG. 4, when the clamp system (10) is assembled, the first clamp first section is configured to connect to the joining member (300) by engaging the plurality of first channel teeth (132) to the first plurality of teeth (323) while simultaneously engaging the plurality of second channel teeth (142) to the third plurality of teeth (333). Correspondingly, the first clamp second section (150) is configured to connect to the joining member by engaging the plurality of third channel teeth (172) to the second plurality of teeth (324) while simultaneously engaging the plurality of fourth channel teeth (182) to the fourth plurality of teeth (334). To provide a tight seal around the first conduit section (400), it is preferred that the teeth of each of the first clamp first section and first clamp second section are engaged to the corresponding teeth of the first protrusion first sidewall (321) and the second protrusion first sidewall (331) until a tight or snug fit about the first conduit section is achieved.

While FIG. 3 and FIG. 4 shows an exemplary system in which toothed engagement members are utilized for connecting the first clamp (100) to the joining member (300), other embodiments may exist.

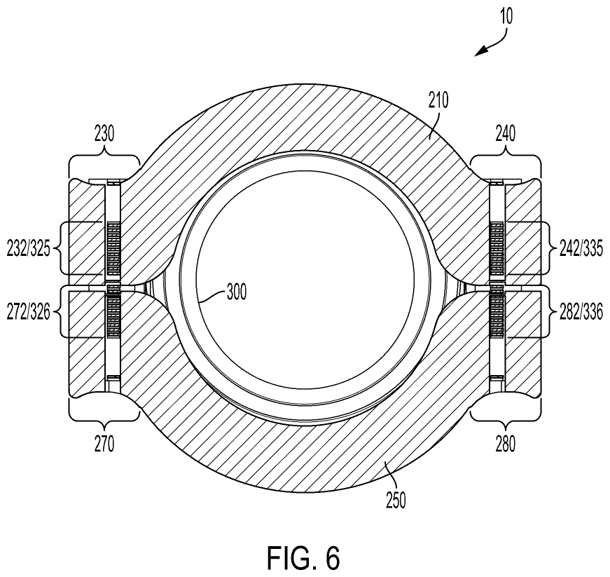

FIG. 5 shows an exploded cross-sectional view of the clamp system (10) across the central axis of the clamp system viewed from the second clamp (200) side of the clamp system with FIG. 6 showing an assembled cross-sectional view of the clamp system of FIG. 5. In FIG. 5 and FIG. 6 additional details of the second clamp and the joining member (300) are visible.

As shown in FIG. 5, the third semi-circular wall (220) of the second clamp first section (210) includes a third inner surface (221) and a third outer surface (222). The third inner surface is configured to seal to a portion of a second conduit section ((500) as shown in FIG. 7) when the clamp system (10) is assembled. The third semi-circular wall may include a third clamping surface which is angled inwardly from the inner surface towards the outer surface. As the second clamp is assembled about two sections of conduit—particularly sections of conduit having flanged terminal ends—the inwardly angled clamping surfaces force the flanged ends of the conduit closer to the joining member to achieve a tight, aseptic sealing between one section of conduit and the joining member.

FIG. 5 further shows details of certain embodiments of the third wall first engagement member (230), which is attached to the third outer surface (222) of the third semi-circular wall (220) at the third wall first end point (223). In the third wall first engagement member shown in FIG. 5 and FIG. 6, the third wall first engagement member comprises a fifth channel (231) with the fifth channel comprising a plurality of fifth channel teeth (232). Preferably, the plurality of fifth channel teeth are arranged vertically along at least a portion of a fifth bottom wall (233) of the fifth channel.

Preferably, the plurality of fifth channel teeth (232) are fine teeth defined by having an integral tooth dimension of at least 1.02 mm and no greater than 1.78 mm. The integral tooth dimension of the teeth may also be at least 1.14 mm, or at least 1.27 mm. The integral tooth dimension of the teeth may also be no greater than 1.65 mm, no greater than 1.52 mm, or no greater than 1.40 mm. The integral tooth dimension may also be defined as a range selected from the group consisting of between 1.02 mm and 1.65 mm, between 1.02 mm and 1.52 mm, between 1.02 mm and 1.40 mm, between 1.14 mm and 1.78 mm, between 1.14 mm and 1.65 mm, between 1.14 mm and 1.52 mm, between 1.14 mm and 1.40 mm, between 1.27 mm and 1.78 mm, between 1.27 mm and 1.65 mm, between 1.27 mm and 1.52 mm, and between 1.27 mm and 1.40 mm.

The third wall second engagement member (240)—attached to the third outer surface (222) of the third semi-circular wall (220) at the third wall second end point (224)—may be of similar or identical construction to the third wall first engagement member (230). That is to say that, in the third wall second engagement member shown in FIG. 5 and FIG. 6, the third wall second engagement member comprises a sixth channel (241) with the sixth channel comprising a plurality of sixth channel teeth (242). Preferably, the plurality of sixth channel teeth are arranged vertically along at least a portion of a sixth bottom wall (243) of the sixth channel.

Preferably, the plurality of sixth channel teeth (242) are fine teeth defined by having an integral tooth dimension of at least 1.02 mm and no greater than 1.78 mm. The integral tooth dimension of the sixth channel teeth may also be at least 1.14 mm, or at least 1.27 mm. The integral tooth dimension of the sixth channel teeth may also be no greater than 1.65 mm, no greater than 1.52 mm, or no greater than 1.40 mm. The integral tooth dimension may also be defined as a range selected from the group consisting of between 1.02 mm and 1.65 mm, between 1.02 mm and 1.52 mm, between 1.02 mm and 1.40 mm, between 1.14 mm and 1.78 mm, between 1.14 mm and 1.65 mm, between 1.14 mm and 1.52 mm, between 1.14 mm and 1.40 mm, between 1.27 mm and 1.78 mm, between 1.27 mm and 1.65 mm, between 1.27 mm and 1.52 mm, and between 1.27 mm and 1.40 mm.

FIG. 5 also shows the fourth semi-circular wall (260) of the second clamp second section (250). As the second clamp second section may be of similar or identical construction to the second clamp first section, the fourth semi-circular wall includes a fourth inner surface (261) and a fourth outer surface (262). The fourth inner surface is configured to seal to a portion of the second conduit section ((500) as shown in FIG. 7) when the clamp system (10) is assembled. The fourth semi-circular wall may include a fourth clamping surface which is angled inwardly from the fourth inner surface towards the fourth outer surface. As the second clamp is assembled about two sections of conduit—particularly sections of conduit having flanged terminal ends—the inwardly angled clamping surfaces force the flanged ends of the conduit closer to the joining member to achieve a tight, aseptic sealing between one section of conduit and the joining member.

FIG. 5 shows further details of certain embodiments of the fourth wall first engagement member (270), which is attached to the fourth outer surface (262) of the fourth semi-circular wall (260) at the fourth wall first end point (263). In the fourth wall first engagement member shown in FIG. 5 and FIG. 6, the fourth wall first engagement member comprises a seventh channel (271) with the seventh channel comprising a plurality of seventh channel teeth (272). Preferably, the plurality of seventh channel teeth are arranged vertically along at least a portion of a seventh bottom wall (273) of the seventh channel.

Preferably, the plurality of seventh channel teeth (272) are fine teeth defined by having an integral tooth dimension of at least 1.02 mm and no greater than 1.78 mm. The integral tooth dimension of the seventh channel teeth may also be at least 1.14 mm, or at least 1.27 mm. The integral tooth dimension of the seventh channel teeth may also be no greater than 1.65 mm, no greater than 1.52 mm, or no greater than 1.40 mm. The integral tooth dimension may also be defined as a range selected from the group consisting of between 1.02 mm and 1.65 mm, between 1.02 mm and 1.52 mm, between 1.02 mm and 1.40 mm, between 1.14 mm and 1.78 mm, between 1.14 mm and 1.65 mm, between 1.14 mm and 1.52 mm, between 1.14 mm and 1.40 mm, between 1.27 mm and 1.78 mm, between 1.27 mm and 1.65 mm, between 1.27 mm and 1.52 mm, and between 1.27 mm and 1.40 mm.

The fourth wall second engagement member (280)—attached to the fourth outer surface (262) of the fourth semi-circular wall (260) at the fourth wall second end point (264)—may be of similar or identical construction to the fourth wall first engagement member (270). That is to say that, in the fourth wall second engagement member shown in FIG. 5 and FIG. 6, the fourth wall second engagement member comprises an eighth channel (281) with the eighth channel comprising a plurality of eighth channel teeth (282). Preferably, the plurality of eighth channel teeth are arranged vertically along at least a portion of an eighth bottom wall (283) of the eighth channel.

Preferably, the plurality of eighth channel teeth (282) are fine teeth defined by having an integral tooth dimension of at least 1.02 mm and no greater than 1.78 mm. The integral tooth dimension of the eighth channel teeth may also be at least 1.14 mm, or at least 1.27 mm. The integral tooth dimension of the eighth channel teeth may also be no greater than 1.65 mm, no greater than 1.52 mm, or no greater than 1.40 mm. The integral tooth dimension may also be defined as a range selected from the group consisting of between 1.02 mm and 1.65 mm, between 1.02 mm and 1.52 mm, between 1.02 mm and 1.40 mm, between 1.14 mm and 1.78 mm, between 1.14 mm and 1.65 mm, between 1.14 mm and 1.52 mm, between 1.14 mm and 1.40 mm, between 1.27 mm and 1.78 mm, between 1.27 mm and 1.65 mm, between 1.27 mm and 1.52 mm, and between 1.27 mm and 1.40 mm.

As shown in FIG. 5, the first protrusion second sidewall (322) may comprise a fifth plurality of teeth (325) and a sixth plurality of teeth (326). The fifth plurality of teeth may be arranged vertically along an upper portion of the first protrusion second sidewall while the sixth plurality of teeth may be arranged vertically along a lower portion of the first protrusion second sidewall. Similarly, the second protrusion second sidewall (332) may comprise a seventh plurality of teeth (335) and an eighth plurality of teeth (336). The seventh plurality of teeth may be arranged vertically along an upper portion of the second protrusion second sidewall while the eighth plurality of teeth may be arranged vertically along a lower portion of the second protrusion second sidewall.

Preferably, the fifth plurality of teeth (325), the sixth plurality of teeth (326), the seventh plurality of teeth (335) and the eighth plurality of teeth (336) are each independently fine teeth defined by having an integral tooth dimension of at least 1.02 mm and no greater than 1.78 mm. The integral tooth dimension of the teeth may also be at least 1.14 mm, or at least 1.27 mm. The integral tooth dimension of the teeth may also be no greater than 1.65 mm, no greater than 1.52 mm, or no greater than 1.40 mm. The integral tooth dimension may also be defined as a range selected from the group consisting of between 1.02 mm and 1.65 mm, between 1.02 mm and 1.52 mm, between 1.02 mm and 1.40 mm, between 1.14 mm and 1.78 mm, between 1.14 mm and 1.65 mm, between 1.14 mm and 1.52 mm, between 1.14 mm and 1.40 mm, between 1.27 mm and 1.78 mm, between 1.27 mm and 1.65 mm, between 1.27 mm and 1.52 mm, and between 1.27 mm and 1.40 mm.

As shown in FIG. 6, when the clamp system (10) is assembled, the second clamp first section is configured to connect to the joining member (300) by engaging the plurality of fifth channel teeth (232) to the fifth plurality of teeth (325) while simultaneously engaging the plurality of sixth channel teeth (242) to the seventh plurality of teeth (335). Correspondingly, the second clamp second section (250) is configured to connect to the joining member by engaging the plurality of seventh channel teeth (272) to the sixth plurality of teeth (326) while simultaneously engaging the plurality of eighth channel teeth (282) to the eighth plurality of teeth (336). To provide a tight seal around the second conduit section (500), it is preferred that the teeth of each of the second clamp first section and second clamp second section are engaged to the corresponding teeth of the first protrusion second sidewall (322) and the second protrusion second sidewall (332) until a tight or snug fit about the second conduit section is achieved.

While the Figures show the clamp system connecting two conduit sections to one another, other uses may exist. For example, the clamp system may be utilized to connect a conduit section to a port in a bag (sometimes referred to as a bag port) thereby allowing the bag to be filled with material passing from the conduit section through the bag port. In such embodiments, the conduit section may be thought of as the first conduit section while the bag port may be thought of as the second conduit section.

While FIG. 5 and FIG. 6 shows an exemplary system in which toothed engagement members are utilized for connecting the second clamp (200) to the joining member (300), other embodiments may exist.

FIG. 7 through FIG. 9, in conjunction with FIG. 1, shows the various steps in assembling the clamp system (10) about a pair of conduit sections (400 and 500). As shown in FIG. 7, the process may begin by engaging the first clamp first section (110) to the first protrusion first sidewall ((321) as shown in FIG. 2) and the second protrusion first sidewall ((331) as shown in FIG. 2) utilizing any of the techniques described herein—such as a toothed engagement. In doing so, the first inner surface ((121) as shown in FIG. 3) engages with a portion of a first conduit section (400). In the system shown in FIG. 7, the first conduit section includes a first flange (410) with the first inner surface engaging with a portion of the first flange.

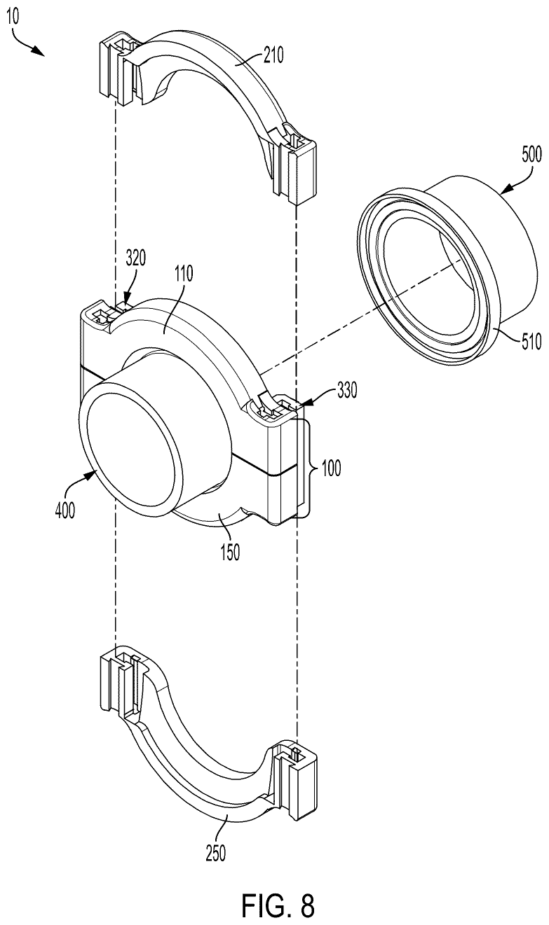

Turning to FIG. 8, the process may continue by engaging the first clamp second section (150) to the first protrusion first sidewall ((321) as shown in FIG. 2) and the second protrusion first sidewall ((331) as shown in FIG. 2) utilizing any of the techniques described herein—such as a toothed engagement. In doing so, the second inner surface ((161) as shown in FIG. 3) engages with a second portion of the first conduit section (400). In the system shown in FIG. 8, the first conduit section includes the first flange ((410) as shown in FIG. 7) with the second inner surface engaging with a second portion of the first flange.

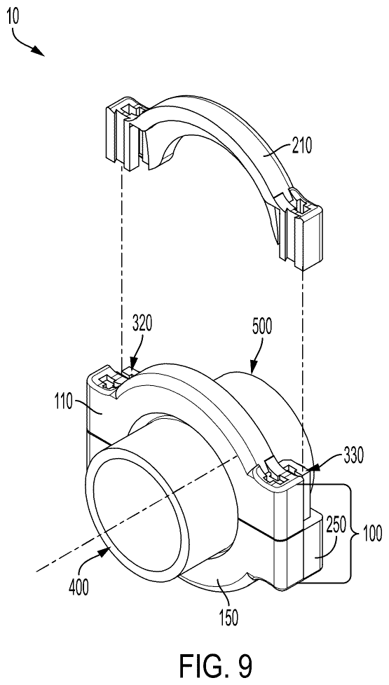

In FIG. 9, the process may continue by engaging the second clamp second section (250) to the first protrusion second sidewall ((322) as shown in FIG. 2) and the second protrusion second sidewall ((332) as shown in FIG. 2) utilizing any of the techniques described herein—such as a toothed engagement. In doing so, the fourth inner surface ((261) as shown in FIG. 5) engages with a second portion of the second conduit section (500). In the system shown in FIG. 9, the second conduit section (500) includes a second flange ((510) as shown in FIG. 2) with the fourth inner surface engaging with a second portion of the second flange.

Finally, reverting to FIG. 1, the process may conclude by engaging the second clamp first section (210) to the first protrusion second sidewall ((322) as shown in FIG. 2) and the second protrusion second sidewall ((332) as shown in FIG. 2) utilizing any of the techniques described herein—such as a toothed engagement. In doing so, the third inner surface ((221) as shown in FIG. 5) engages with a portion of the second conduit section ((500) as shown in FIG. 2). In the system shown in FIG. 1, the second conduit section includes a second flange ((510) as shown in FIG. 2) with the third inner surface engaging with a portion of the second flange.

While FIG. 1, and FIG. 7 to FIG. 9 show the clamp sections being engaged to the joining member (300) in a particular order starting with the first clamp first section (110), proceeding to the first clamp second section (150), then to the second clamp second section (250), and finishing with the second clamp first section (210), the order of assembly may be varied in any number of ways. That is to say that the first clamp first section may be connected to the joining member in the first, second, third, or fourth step. Similarly, the first clamp second section may be connected to the joining member in the first, second, third, or fourth step. The second clamp first section may be connected to the joining member in the first, second, third, or fourth step. Similarly, the second clamp second section may be connected to the joining member in the first, second, third, or fourth step.

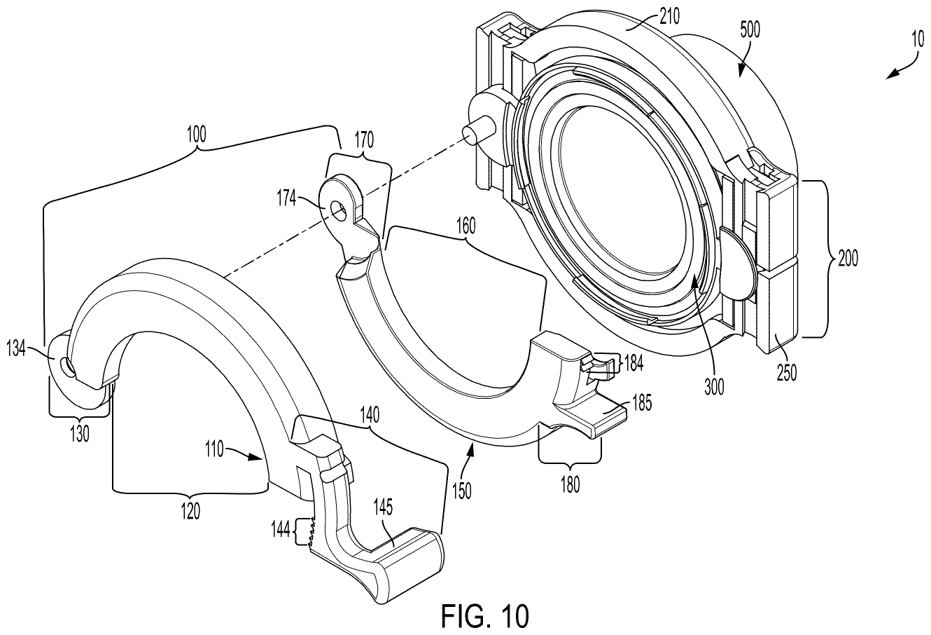

FIG. 10 through FIG. 12 illustrates an alternative embodiment of the clamp system. As shown in FIG. 10 the second clamp (200) may be substantially similar or identical to the second clamp shown in the embodiment in FIG. 1 through FIG. 9. However, the first clamp (100) in the embodiment shown in FIG. 10 through FIG. 12 is a hinged clamp.

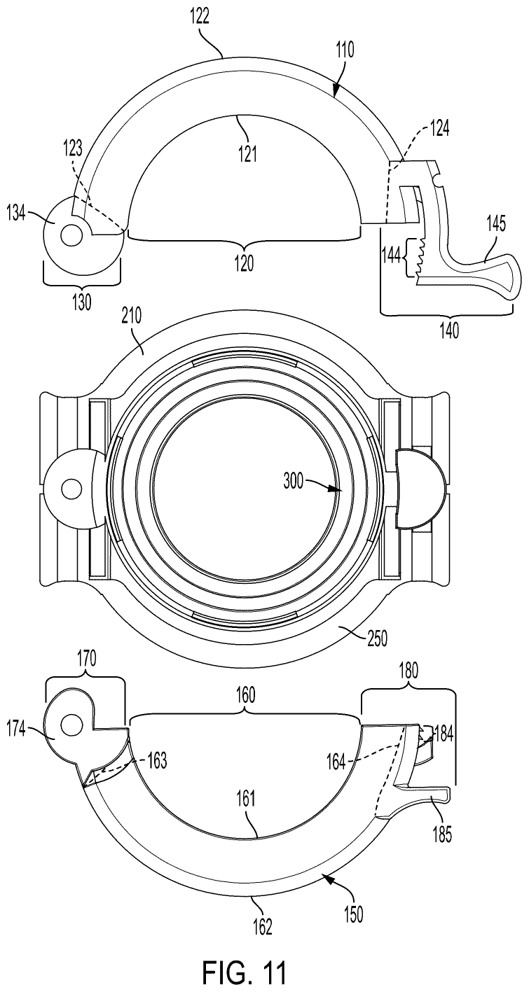

Like the embodiment shown in FIG. 1 through FIG. 9, the hinged clamp shown in FIG. 10 through FIG. 12 includes a first clamp first section (110) and a first clamp second section (150). The first clamp first section includes a first semi-circular wall (120). Attached to opposing end points ((123) and (124) as shown in FIG. 11) of the first semi-circular wall are a first wall first engagement member (130) and a first wall second engagement member (140). Similarly, the first clamp second section includes a second semi-circular wall (160). Attached to opposing end points ((163) and (164) as shown in FIG. 11) of the second semi-circular wall are a second wall first engagement member (170) and a second wall second engagement member (180).

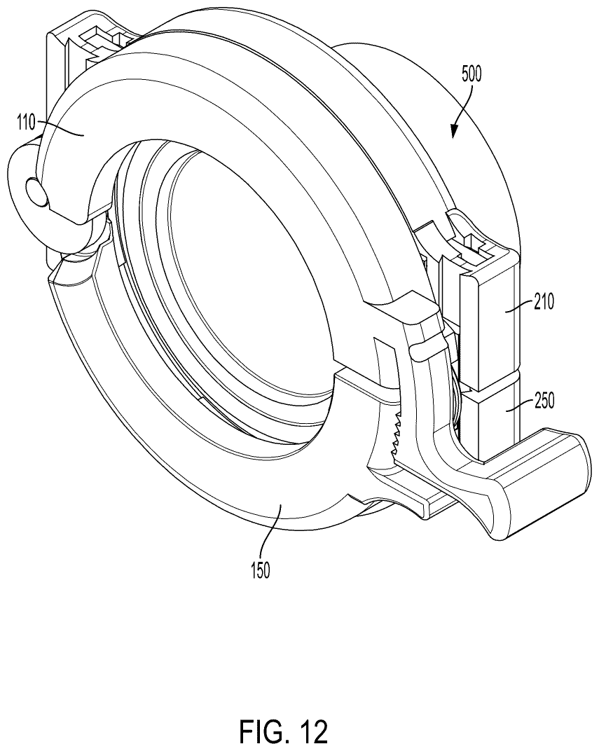

In the embodiment shown in FIG. 10 through FIG. 12, the first wall first engagement member (130) comprises a first hinge section (134) while the second wall first engagement member (170) comprises a second hinge section (174). When assembled as shown in FIG. 12, the first clamp first section is configured to connect (partially) to the first clamp second section by mating the first hinge section to the second hinge section.

Also shown in the embodiment in FIG. 10 through FIG. 12, the first wall second engagement member (140) comprises a first plurality of inwardly facing teeth (144) while the second wall second engagement member (180) comprises a first plurality of outwardly facing teeth (184). When assembled as shown in FIG. 12, the first clamp first section is configured to connect (partially) to the first clamp second section by mating the first plurality of inwardly facing teeth to the first plurality of outwardly facing teeth. In conjunction with mating the first hinge section (134) to the second hinge section (174), mating the first plurality of inwardly facing teeth to the first plurality of outwardly facing teeth provides for an assembled first clamp (100).

In some embodiments, the first wall first second engagement member (140) and/or the second wall second engagement member (180) may include a thumb protrusion (referred to herein as a first thumb protrusion (145) and a second thumb protrusion (185) respectively). When present, the thumb protrusion(s) allow a user to easily pivot the first clamp first section (110) and the first clamp second section (150) about an axis formed by the first hinge section (134) and the second hinge section (174) to mate the first plurality of inwardly facing teeth (144) with the first plurality of outwardly facing teeth (184) during assembly of the first clamp (100).

The components of the clamp system disclosed herein—including the first clamp first section (110), the first clamp second section (150), the second clamp first section (210), the second clamp second section (250), and/or the joining member (300)—may be fabricated of any number of materials utilizing any number of manufacturing techniques. Non-limiting examples of such materials include polymeric materials, glass filled polymer materials—specifically glass filled nylon, and silicone materials. Non-limiting examples of such manufacturing techniques include injection molding and additive manufacturing (also referred to as 3D printing).

The clamp systems disclosed herein allow for assemblers to quickly and easily assemble single-use aseptic pressurized chemical manufacturing systems. The toothed engagements ensure that the user can quickly snap or click the clamp sections together to a position where they maintain aseptic sealing of conduit sections or other chemical manufacturing equipment. The teeth then prevent—or at least reduce the risk of—leaking breaking, or rupturing as the teeth cannot be pulled apart of disengaged once assembled without the use of an external tool such as the blade of a screw driver to physically pry the clamp sections apart. The clamp systems disclosed herein also allow for the clamp(s) and conduit section(s) to be provided to a user at least partially pre-assembled (following optional sterilization using gamma, EtO, or x-ray sterilization methods) which reduces the amount of user contact with the components during assembly and thereby reduces the risk of part contamination during assembly.

While the system has been described as having one or more exemplary designs, the present system may be further modified within the spirit and scope of this disclosure. This application is therefore intended to cover any variations, uses, or adaptations of the system using its general principles.

What is claimed is:

1. A clamp system (10) comprising:
a first clamp (100) comprising:
a first clamp first section (110) having:
a first semi-circular wall (120) having a first inner surface (121), a first outer surface (122), a first wall first end point (123), and a first wall second end point (124);
a first wall first engagement member (130) attached to the first outer surface at the first wall first end point; and
a first wall second engagement member (140) attached to the first outer surface at the first wall second end point; and
a first clamp second section (150) having:
a second semi-circular wall (160) having a second inner surface (161), a second outer surface (162), a second wall first end point (163), and a second wall second end point (164);
a second wall first engagement member (170) attached to the second outer surface at the second wall first end point; and
a second wall second engagement member (180) attached to the second outer surface at the second wall second end point;
a second clamp (200) comprising:
a second clamp first section (210) having:
a third semi-circular wall (220) having a third inner surface (221), a third outer surface (222), a third wall first end point (223), and a third wall second end point (224);
a third wall first engagement member (230) attached to the third outer surface at the third wall first end point; and
a third wall second engagement member (240) attached to the third outer surface at the third wall second end point; and
a second clamp second section (250) having:
a fourth semi-circular wall (260) having a fourth inner surface (261), a fourth outer surface (262), a fourth wall first end point (263), and a fourth wall second end point (264);
a fourth wall first engagement member (270) attached to the fourth outer surface at the fourth wall first end point; and
a fourth wall second engagement member (280) attached to the fourth outer surface at the fourth wall second end point; and
a joining member (300) comprising:
a cylindrical section (310);
a first protrusion (320) attached to and extending from a cylindrical section outer edge (311); and
a second protrusion (330) attached to and extending from the cylindrical section outer edge at a position approximately 180° apart from the first protrusion about a circumference of the cylindrical section; and
wherein the first wall first engagement member is configured to connect to a first portion of the first protrusion; the first wall second engagement member is configured to connect to a first portion of the second protrusion; the second wall first engagement member is configured to connect to a second portion of the first protrusion; the second wall second engagement member is configured to connect to a second portion of the second protrusion; the third wall first engagement member is configured to connect to a third portion of the first protrusion; the third wall second engagement member is configured to connect to a third portion of the second protrusion; the fourth wall first engagement member is configured to connect to a fourth portion of the first protrusion; and the fourth wall second engagement member is configured to connect to a fourth portion of the second protrusion.

2. The clamp system of claim 1, wherein:
the first wall first engagement member comprises a first channel (131) comprising a plurality of first channel teeth (132);
the first wall second engagement member comprises a second channel (141) comprising a plurality of second channel teeth (142);
the second wall first engagement member comprises a third channel (171) comprising a plurality of third channel teeth (172);
the second wall second engagement member comprises a fourth channel (181) comprising a plurality of fourth channel teeth (182);
the first protrusion comprises a first protrusion first sidewall (321) comprising a first plurality of teeth (323) and a second plurality of teeth (324); and
the second protrusion comprises a second protrusion first sidewall (331) comprising a third plurality of teeth (333) and a fourth plurality of teeth (334); and
wherein the first clamp first section is configured to connect to the joining member by engaging the plurality of first channel teeth to the first plurality of teeth and the plurality of second channel teeth to the third plurality of teeth; and the first clamp second section is configured to connect to the joining member by engaging the plurality of third channel teeth to the second plurality of teeth and the plurality of fourth channel teeth to the fourth plurality of teeth.

3. The clamp system of claim 2, wherein the plurality of first channel teeth are arranged vertically along at least a portion of a first bottom wall (133) of the first channel, the plurality of second channel teeth are arranged vertically along at least a portion of a second bottom wall (143) of the second channel, the plurality of third channel teeth are arranged vertically along at least a portion of a third bottom wall (173) of the third channel, and the plurality of fourth channel teeth are arranged vertically along at least a portion of a fourth bottom wall (183) of the fourth channel.

4. The clamp system of claim 2, wherein the first plurality of teeth are arranged vertically along an upper portion of the first protrusion first sidewall, the second plurality of teeth are arranged vertically along a lower portion of the first protrusion first sidewall, the third plurality of teeth are arranged vertically along an upper portion of the second protrusion first sidewall, and the fourth plurality of teeth are arranged vertically along a lower portion of the second protrusion first sidewall.

5. The clamp system of claim 1, wherein:
the third wall first engagement member comprises a fifth channel (231) comprising a plurality of fifth channel teeth (232);
the third wall second engagement member comprises a sixth channel (241) comprising a plurality of sixth channel teeth (242);
the fourth wall first engagement member comprises a seventh channel (271) comprising a plurality of seventh channel teeth (272);
the fourth wall second engagement member comprises an eighth channel (281) comprising a plurality of eighth channel teeth (282);
the first protrusion comprises a first protrusion second sidewall (322) comprising a fifth plurality of teeth (325) and a sixth plurality of teeth (326); and
the second protrusion comprises a second protrusion second sidewall (332) comprising a seventh plurality of teeth (335) and an eighth plurality of teeth (336); and
wherein the second clamp first section is configured to connect to the joining member by engaging the plurality of fifth channel teeth to the plurality of fifth teeth and engaging the plurality of sixth channel teeth to the seventh plurality of teeth; and the second clamp second section is configured to connect to the joining member by engaging the plurality of seventh channel teeth to the plurality of sixth teeth and engaging the plurality of eighth channel teeth to the eighth plurality of teeth.

6. The clamp system of claim 5, wherein the plurality of fifth channel teeth are arranged vertically along at least a portion of a fifth bottom wall (233) of the fifth channel, the plurality of sixth channel teeth are arranged vertically along at least a portion of a sixth bottom wall (243) of the sixth channel, the plurality of seventh channel teeth are arranged vertically along at least a portion of a seventh bottom (273) wall of the seventh channel, and the plurality of eighth channel teeth are arranged vertically along at least a portion of an eighth bottom wall (283) of the eighth channel.

7. The clamp system of claim 5, wherein the fifth plurality of teeth are arranged vertically along an upper portion of the first protrusion second sidewall, the sixth plurality of teeth are arranged vertically along a lower portion of the first protrusion second sidewall, the seventh plurality of teeth are arranged vertically along an upper portion of the second protrusion second sidewall, and the eighth plurality of teeth are arranged vertically along a lower portion of the second protrusion second sidewall.

8. The clamp system of claim 1, wherein the first protrusion comprises a first protrusion channel (327) located between the first protrusion first sidewall and the first protrusion second sidewall.

9. The clamp system of claim 1, wherein the second protrusion comprises a second protrusion channel (337) located between the second protrusion first sidewall and the second protrusion second sidewall.

10. The clamp system of claim 1, wherein
the first wall first engagement member comprises a first hinge section (134);
the first wall second engagement member comprises a first plurality of inwardly facing teeth (144);
the second wall first engagement member comprises a second hinge section (174); and
the second wall second engagement member comprises a first plurality of outwardly facing teeth (184); and
wherein the first clamp first section is configured to connect to the first clamp second section by mating the first hinge section to the second hinge section and mating the first plurality of inwardly facing teeth to the first plurality of outwardly facing teeth.

11. The clamp system of claim 10, wherein:
the third wall first engagement member comprises a fifth channel (231) comprising a plurality of fifth channel teeth (232);
the third wall second engagement member comprises a sixth channel (241) comprising a plurality of sixth channel teeth (242);
the fourth wall first engagement member comprises a seventh channel (271) comprising a plurality of seventh channel teeth (272);
the fourth wall second engagement member comprises an eighth channel (281) comprising a plurality of eighth channel teeth (282);
the first protrusion comprises a first protrusion second sidewall (322) comprising a fifth plurality of teeth (325) and a sixth plurality of teeth (326); and
the second protrusion comprises a second protrusion second sidewall (332) comprising a seventh plurality of teeth (335) and an eighth plurality of teeth (336); and
wherein the second clamp first section is configured to connect to the joining member by engaging the plurality of fifth channel teeth to the plurality of fifth teeth and engaging the plurality of sixth channel teeth to the seventh plurality of teeth; and the second clamp second section is configured to connect to the joining member by engaging the plurality of seventh channel teeth to the plurality of sixth teeth and engaging the plurality of eighth channel teeth to the eighth plurality of teeth.

12. The clamp system of claim 11, wherein the plurality of fifth channel teeth are arranged vertically along at least a portion of a fifth bottom wall (233) of the fifth channel, the plurality of sixth channel teeth are arranged vertically along at least a portion of a sixth bottom wall (243) of the sixth channel, the plurality of seventh channel teeth are arranged vertically along at least a portion of a seventh bottom (273) wall of the seventh channel, and the plurality of eighth channel teeth are arranged vertically along at least a portion of an eighth bottom wall (283) of the eighth channel.

13. The clamp system of claim 11, wherein the fifth plurality of teeth are arranged vertically along an upper portion of the first protrusion second sidewall, the sixth plurality of teeth are arranged vertically along a lower portion of the first protrusion second sidewall, the seventh plurality of teeth are arranged vertically along an upper portion of the second protrusion second sidewall, and the eighth plurality of teeth are arranged vertically along a lower portion of the second protrusion second sidewall.

14. The clamp system of claim 11, wherein the first protrusion comprises a first protrusion channel (327) located between the first protrusion first sidewall and the first protrusion second sidewall.

15. The clamp system of claim 11, wherein the second protrusion comprises a second protrusion channel (337) located between the second protrusion first sidewall and the second protrusion second sidewall.

16. The clamp system of claim 1, wherein the first semi-circular wall includes a first clamping surface which is angled inwardly from the first inner surface towards the first outer surface.

17. The clamp system of claim 1, wherein the second semi-circular wall includes a second clamping surface which is angled inwardly from the second inner surface towards the second outer surface.

18. The clamp system of claim 1, wherein the third semi-circular wall includes a third clamping surface which is angled inwardly from the third inner surface towards the third outer surface.

19. The clamp system of claim 1, wherein the fourth semi-circular wall includes a fourth clamping surface which is angled inwardly from the fourth inner surface towards the fourth outer surface.

20. The clamp system of claim 1, wherein the first clamp, the second clamp member, and the joining member are each individually comprised of a material selected from the group consisting of polymeric materials, glass filled polymer materials, and silicone materials.
